(19) United States
(12) Patent Application Publication
(10) Pub. No.: US 2012/0124762 A1
(43) Pub. Date: May 24, 2012

(54) DEORDORIZING MEMBER WITH CLEANING ABILITY AND METHOD

(76) Inventors: Mark Caligaris, Greenville, SC (US); Nigel Flynn, Flowery Branch, GA (US); Taylor Renee Kopacka, Alpharetta, GA (US)

(21) Appl. No.: 12/951,817

(22) Filed: Nov. 22, 2010

(51) Int. Cl. A47L 25/00; B05D 1/38; B05D 3/02; B05D 5/10

(52) U.S. Cl. 15/104.002; 427/207.1; 427/202

(57) ABSTRACT

A deodorizing member is provided that has a base sheet that carries an adhesive layer. The adhesive layer has a tackiness sufficient to adhere undesired objects from an item thereon when placed into contact with the undesired objects. A plurality of deodorizing particles are carried by the adhesive layer, and at least one has a portion thereof that is not covered by an upper surface of the adhesive layer. The deodorizing particles deodorize the item. An associated method of manufacture is also provided.

### FIELD OF THE INVENTION

The present invention relates generally to deodorizing members. More particularly, the present application involves a deodorizing member that is capable of removing both undesired objects and unwanted odors from an item to be cleaned. An associated method of manufacture is also provided.

### BACKGROUND

Items such as clothing, tablecloths, furniture, and pets are often cleaned in order to remove unwanted objects such as lint, dust, and dander. In order to effect this removal, cleaning tools are known, such as lint brushes, that can be used to pick up unwanted objects from surfaces. Lint brushes include a handle with a mounting member that is rotationally attached to the handle. A series of sheets with adhesive are rolled onto the mounting member. The user may grasp the handle of the lint brush and run the same over the object to be cleaned. The mounting member and attached sheets rotate on the item being cleaned and unwanted objects, such as lint, are attached to the adhesive on the sheets. The adhesive is selected in such a manner that it has tackiness sufficient to cause lint to be attached upon contact, yet not tacky enough to pull fabric or other portions of the actual clothing article from the clothing. Once the sheet is filled with lint, the user may tear the sheet from the lint brush to expose a subsequent fresh and clean sheet for use.

Although capable of cleaning lint from clothing, lint brushes are not capable of deodorizing clothing. A separate washing or dry cleaning step must be used in order to remove odors from the clothing. Other items such as brushes and wiping gloves are known to clean or remove unwanted objects from various items. However, these conventional cleaning tools fail to allow a user to both clean by removing unwanted items and deodorize the object being cleaned. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a cross-sectional view of a deodorizing member in accordance with one exemplary embodiment.

FIG. 2 is a cross-sectional view of a deodorizing member arranged into stacked sections and carried by a mounting member in accordance with one exemplary embodiment.

FIG. 3 is cross-sectional view of a deodorizing member in accordance with another exemplary embodiment.

FIG. 4 is top plan view of a deodorizing member in accordance with another exemplary embodiment.

FIG. 5 is a perspective view of a deodorizing member used as a lint brush.

FIG. 6 is a top plan view of FIG. 5.

FIG. 7 is an enlarged cross-sectional view of a portion of the deodorizing member of FIG. 5.

FIG. 8 is a perspective view of a deodorizing member used as a lint brush with a spray nozzle in accordance with another exemplary embodiment.

FIG. 9 is a front plan view of a deodorizing member used as a wiping glove in accordance with an additional exemplary embodiment.

FIG. 10 is a side view of a deodorizing member used as an animal lint brush in accordance with another exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162, Further, all limits mentioned herein include all other limits included in the mentioned limits. For instance, a limit of up to 7 also includes a limit of up to 5, up to 3, and up to 4.5.

The present invention provides for a deodorizing member 10 that is capable of picking up undesired objects 18, such as lint, from an item 16 such as fabric of a piece of clothing. The deodorizing member 10 includes a plurality of deodorizing particles 20 that function to absorb, neutralize, or otherwise remove odiferous molecules associated with the item 16 to improve the smell of the item 16. As such, the deodorizing member 10 may effect both a cleaning and a deodorizing to the item 16. The deodorizing member 10 can be incorporated into a variety of tools such as lint brushes, wiping gloves, animal lint cleaners, brushes, or mops.

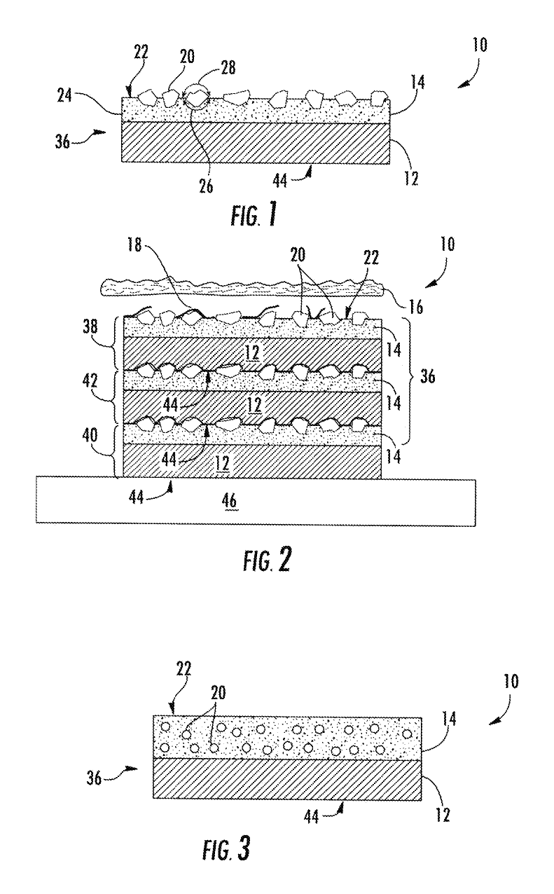

FIG. 1 illustrates a deodorizing member 10 in accordance with one exemplary embodiment. The deodorizing member 10 has a base sheet 12 that is used to carry other portions of the deodorizing member 10. The base sheet 12 may be made of a variety of materials. For example, the base sheet 12 may be made of paper, paperboard, metal, film, non-woven materials such as non-woven melt blown fibers, or even woven materials in accordance with certain embodiments.

An adhesive layer 14 can be carried by the base sheet 12 and may be disposed so as to completely cover the upper surface of the base sheet 12. The adhesive layer 14 has an upper surface 22 that is used to engage undesired objects 18 such as lint and hold the undesired objects 18 thereon. The adhesive layer 14 can be made of any number of different substances. The adhesive layer 14 may be a pressure sensitive adhesive in one embodiment. Any type of known pressure sensitive adhesive may be used in the adhesive layer 14. The pressure sensitive adhesive may be applied in a melt or liquid form to the base sheet 12 in some embodiments. The base sheet 12 and adhesive layer 14 may be provided as a single unit from a manufacturer, or may be provided as separate parts that are attached to one another or otherwise arranged so that the base sheet 12 may carry the adhesive layer 14. The adhesive layer 14 should be provided to have a tackiness that functions to adhere the undesired objects 18 thereto, but not so tacky as to hold onto the item 16 being cleaned or to pull portions of the item 16, such as fabric, off of the item 16 itself. As such, the adhesive layer 14 should be selected to have an optimum tackiness level that allows for some adhesion but not too much adhesion. Pressure applied by the adhesive layer 14 may also function in determining how much of the undesired objects 18 are adhered to the adhesive layer 14. Adhesion strength may be measured by a standard known as peel adhesion which is the peak force required to separate two adhered materials. In accordance with one exemplary embodiment, the peel adhesion of the adhesive layer 14 may be from 0.78 kgf to 0.85 kgf. The peel adhesion of this adhesive layer 14 may be determined though adhesion with a woven blanket as the item 16 with the undesired object 18 being dog hair. However, it is to be understood that various peel adhesion strengths may be provided by the adhesive layer 14 in accordance with different versions of the deodorizing member 10. The adhesive layer 14 may have any thickness. For example, the adhesive layer 14 may be 0.001 inches in thickness which is measured from the bottom surface to the opposite upper surface 22. In other arrangements, the adhesive layer 14 has a thickness from 1-4 microns.

The deodorizing member 10 includes a plurality of deodorizing particles 20. The deodorizing particles 20 may be made of a variety of different materials. For example, in one exemplary embodiment the deodorizing particles 20 are made of sodium bicarbonate. Sodium bicarbonate is sometimes known as sodium hydrogen carbonate, sodium acid carbonate, baking soda, and bicarbonate of soda. In other exemplary embodiments, the deodorizing particles 20 can be potassium bicarbonate. In yet other arrangements, the deodorizing particles 20 may be cyclodextrin and/or zeolite. In still further embodiments, the deodorizing particles 20 may be a combination of sodium bicarbonate and potassium bicarbonate. The deodorizing particles 20 may be from 0.5-600 microns in size, from 6-150 microns, or from 25-50 microns with the majority being 40 microns in accordance with different exemplary embodiments. The deodorizing particles 20 may be hydrophilic in certain arrangements, and the item 16 being cleaned may be wetted in order to enhance the odor absorption reaction by the deodorizing particle 20 and the odiferous molecules being removed.

The deodorizing member 10 may be placed into direct contact with the item 16 and pressure may be applied thereto so that the deodorizing particles 20 are rubbed or pressed against the surface of the item 16. This rubbing or pressure may function to increase the reaction and cleaning effect of the deodorizing particle 20 and the item 16 being cleaned. However, other arrangements are possible in which the deodorizing particle 20 does not in fact engage the item 16 being cleaned yet odiferous molecules associated with the item 16 can be neutralized and hence removed even without direct contact. Here, the odiferous molecules will move off of the item 16 and engage the deodorizing particles 20 for removal.

With respect to FIG. 1, the deodorizing particles 20 are carried by the adhesive layer 14 so as to be disposed near the upper surface 22 of the adhesive layer 14. The deodorizing particles 20 have a bonded portion 26 that is located under the upper surface 22. The deodorizing particles 20 and the adhesive layer 14 are thus attached at the bonded portion 26. The deodorizing particles 20 have an exposed portion 28 that extends above the upper surface 22. In some arrangements, the exposed portion 28 may be below the upper surface 22 or may be flush with the upper surface 22 but exposed such that the adhesive layer 14 does not cover the exposed portion 28. The exposed portion 28 may extend any amount over the upper surface 22. In use, the bonded portion 26 may be strong enough to hold the deodorizing particles 20 to the adhesive layer 14 so that pressing or rubbing the deodorizing member 10 against the item 16 being cleaned will not cause the deodorizing particles 20 to be rubbed off and placed onto the item 16.

The deodorizing member 10 may also include cyclodextrin 24 incorporated therewith. In other exemplary embodiments, the cyclodextrin 24 is not present at all in the deodorizing member 10. The cyclodextrin 24 can be located in relation to the upper surface 22 in the same manner as previously discussed with respect to the deodorizing particles 20 and a repeat of this information is not necessary. Additionally or alternatively, some or all of the cyclodextrin 24 can be located within the adhesive layer 14 so that it is completely covered by the upper surface 22 and hence completely embedded within the adhesive layer 14. The cyclodextrin 24 used may be α, β, or γ cyclodextrin 24 in certain exemplary embodiments. The cyclodextrin 24 that is selected may be complexed, uncomplexed, or a mixture of both. The cyclodextrin 24 may be provided in a percentage of from 1%-10% of the weight of the total of the cyclodextrin 24, adhesive layer 14 and deodorizing particles 20. In other arrangements, the cyclodextrin 24 is provided in a percentage of from 1%-10% of the weight percentage of the total of the cyclodextrin 24 and deodorizing particles 20. In yet other exemplary embodiments, the cyclodextrin 24 is provided from 1%-10% by weight percentage of the total of the cyclodextrin 24 and the total of the cyclodextrin 24, base sheet 12, adhesive layer 14, and deodorizing particles 20. The cyclodextrin 24 may be of any size. For example, the cyclodextrin 24 is 100 microns in accordance with one exemplary embodiment. The cyclodextrin 24 may function to add odors to the item 16.

The cyclodextrin 24 is used to trap, capture and/or remove odors of the item 16 such as those caused by cigarette smoke or perfume. The cyclodextrin 24 may assist in the deodorization process through direct contact with the item 16 by pressing the deodorizing member 10 against the item 16, or through molecular transfer and chemical reaction or deposition onto the item 16.

With reference now to FIG. 2, the deodorizing member 10 is configured into a plurality of sections 36 that are stacked onto one another. Any number of sections 36 may be present in various arrangements. For example, from 2-5, from 5-10, from 15-20 or up to 100 sections 36 may be present in various arrangements. Further, in certain arrangements, only a single section is present such as that illustrated in FIG. 1. Each one of the sections 36 can include the base sheet 12, adhesive layer 14, deodorizing particles 20 and cyclodextrin 24 if present. The sections 36 are stacked onto one another so that once the upper section 38 is used up by becoming completely polluted with the undesired objects 18 and by using up some or all of the deodorizing life of the deodorizing particles 20, the upper section 36 can be removed and discarded. Removal of the upper section 36 will cause the intermediate section 42 to be exposed and thus a fresh amount of adhesive layer 14 and deodorizing particles 20 can be employed to achieve cleaning and deodorization.

Once the intermediate section 42 is used up, it too can be removed to reveal the lower section 40 that has a fresh adhesive layer 14 and deodorizing particles 20. Again, any number of sections 36 can be used in this regard. The bottom surface 44 of the base sheet 12 may be made of a substance that allows for easy removal from the adhesive layer 14. In some embodiments, the bottom surface 44 may include a silicon release agent as known in the art to allow the adhesive layer 14 to easily release when pulled. Alternatively, a separate release liner substrate may be positioned adjacent to substrate to allow the stacked or rolled configuration of the adhesive substrate to be utilized. It is also envisioned that substrates, such as high gloss papers, can also be used as a substrate with the adhesive and odor absorbing molecules on one surface such that the inherent properties paper will allow for adhesive layer 14 to be easily released when engaged. The base sheet 12 may thus be made of a single component or a number of different components. The deodorizing particles 20 of the intermediate section 42 may press against the bottom surface 44 of the upper section 38 as shown in FIG. 2. This pressing may be of a degree that it does not cause damage to the deodorizing particles 20 or bottom surface 44 such that the deodorizing particles 20 would be broken off or such that the bottom surface 44 would not be able to engage the adhesive layer 14 of the intermediate section 42 to effect attachment thereon. The sections 36 can be formed in a variety of shapes for different applications. They can be re-wound into rolls or formed in layers and die cut into a desired shape.

The base sheet 12 of the lower section 40 may be mounted onto a mounting member 46. This attachment may be permanent or removable. The user can grasp the mounting member 46 in order to move the adhesive layer 14 of the uppermost section 36 against an item 16 or proximate to an item 16 as desired. The mounting member 46 may be grasped by the user, or the mounting member 46 may itself be attached to some other item that is in turn grasped by the user in order to allow the mounting member 46 to be manipulated. The mounting member 46 may be made of any material and can be made of plastic, metal, paper, or fabric in various arrangements. The mounting member 46 may be a handle in some embodiments. The mounting member 46 may be a block of material and can have a generally rectangular shape with a thickness that is greater than that of the sections 36.

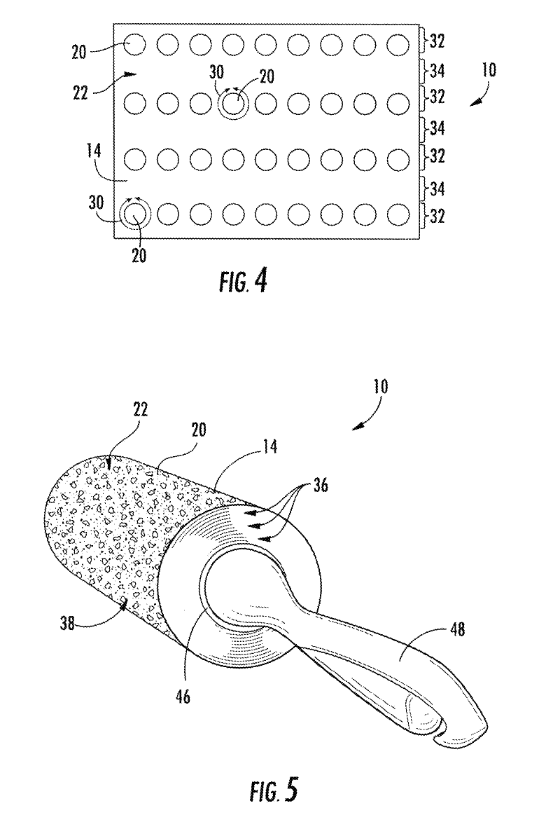

The deodorizing member 10 may be manufactured in a number of different ways. With reference now to FIG. 3, the deodorizing particles 20 can be mixed with the adhesive layer 14 before being applied to the base sheet 12. The combined adhesive layer 14 and deodorizing particles 20 mixture can then be subsequently applied to the base sheet 12. Prior mixing of the adhesive layer 14 and deodorizing particles 20 may cause the deodorizing particles 20 to be randomly disposed within and uniformly disposed throughout the adhesive layer 14 once the adhesive layer 14 and deodorizing particles 20 are applied to the base sheet 12. In some embodiments, none of the deodorizing particles 20 are present above the upper surface 22 and all of the deodorizing particles 20 are covered by the upper surface 22 and hence completely impregnated within the adhesive layer 14. In other embodiments, some of the impregnated deodorizing particles 20 can have exposed portions 28 are previously discussed. If cyclodextrin 24 is employed, the cyclodextrin 24 can be combined with the deodorizing particles 20 and adhesive layer 14 mixture before application to the base sheet 12 and may be dispersed in the resulting adhesive layer 14 in manners similar to those all ready discussed with respect to the deodorizing particles 20.

Although dispersed through the adhesive layer 14, the deodorizing particles 20 were surprisingly found to function to provide deodorization to the item 16 when using the deodorizing member 10 to remove undesired objects 18. Here, the odiferous molecules can be absorbed through the adhesive layer 14 for deodorization. Alternatively, pressing or rubbing of the deodorizing member 10 against the item 16 may cause deodoring particles 20 to be rubbed against odiferous molecules of the item 16 or molecules of the deodorizing member 10 can be transferred through the adhesive layer 14 to the item 16 to cause deodorization. Applicants do not wish to be bound to a particular theory of operation with respect to how the deodorization process occurs when all or a majority of the deodorizing particles 20 are completely under the upper surface 22. The arrangement shown in FIG. 3 may be that of the deodorizing member 10 once the user has it and is just about to clean the item 16.

In accordance with this invention, is further been found that the paper substrate having a deodorizing amount of baking soda applied thereto, can also operate as a passive odor absorbing apparatus. For instance, the exposed baking soda substrate present on or within the adhesive can function to absorb odors in the surrounding environment. Accordingly, the various embodiments set forth in this application allow the baking soda to remove and neutralize airborne odors in the vicinity by passive absorption.

Another method of manufacture of the deodorizing member 10 involves first applying the adhesive layer 14 to the base sheet 12. This application may is be effected by spraying the adhesive layer 14 onto the base sheet 12, by pressing the adhesive layer 14 thereon, or by integrally forming the adhesive layer 14 with the base sheet 12. The adhesive layer 14 may be heated so that at least the upper surface 22 is softened. The entire adhesive layer 14 is heated in one embodiment. The heating should be sufficient to soften the upper surface 22 without reaching temperatures where degradation of the deodorizing particles 20 occurs. If too much heat is applied to the deodorizing particles 20, they may chemically react or otherwise break down thus causing them to lose effectiveness in performing their deodorizing function. The softened adhesive layer 14, or upper surface 22 will allow the deodorizing particles 20 to be more easily implanted into the adhesive layer 14 so that they can achieve the positioning shown in the figures and as described above. The amount of heat applied may cause the temperature of the adhesive layer 14 to be up to but not over 125 ° in some embodiments. In others, the adhesive layer 14 may be heated to a maximum temperature that is from 110° to 125°. In still other exemplary embodiments, the adhesive layer 14 can be heated over 125°. Although this may cause degradation of some of the deodorizing particles 20, or may result in partial degradation of all of the deodorizing particles 20, some or all of the deodorizing particles 20 may still maintain some functioning and can still be used to effect deodorization. Heating over 125° may cause the deodorizing particles 20, such as baking soda, to degrade into a carbon dioxide gas, water, and a salt.

The heated adhesive layer 14 may also assist in the insertion of the cyclodextrin 24 if it is used in the deodorizing member 10. The temperature to which the adhesive layer 14 may be heated may likewise cause the cyclodextrin 24 to degrade and thus the temperature may not exceed that previously discussed with respect to the deodorizing particles 20 to ensure that degradation does not occur. The cyclodextrin 24 can be co-applied with the deodorizing particles 20 when the adhesive layer 14 is heated. The cyclodextrin 24 could also be added to the adhesive layer 14 prior to the addition of the deodorizing particles 20, or subsequent to the addition of the deodorizing particles 20. The deodorizing particles 20, including optional additions of cyclodextrin 24 and other deodorizing particles, may be sprayed onto the adhesive layer 14, dropped onto the adhesive layer 14, pressed onto the adhesive layer 14 with the use of a roll such a calender roll, sprinkled onto the adhesive layer 14, or otherwise placed onto the adhesive layer 14 in the applying step. Adhesive properties of the adhesive layer 14 in addition to the heating of the adhesive layer 14 may create the bond between the adhesive layer 14 and the bonded portion 26 of the deodorizing particles 20 to cause retention of the deodorizing particles 20. The cyclodextrin 24 if present may be bonded to the adhesive layer 14 under the same circumstances.

With reference now to FIG. 4, a top plan view of the deodorizing member 10 is illustrated. As shown, the deodorizing particles 20 are disposed on the adhesive layer 14 in a series of rows 32. Empty portions 34 are disposed between the rows 32 and are simply portions of the upper surface 22 with no deodorizing particles 20 present. The empty portions 34 may all be of the same length, or may be of different lengths in accordance with other embodiments. Although not labeled, additional empty portions 34 are present between the deodorizing particles 20 within the rows 34. As such, the deodorizing particles 20 do not extend completely within a row 34 along the entire adhesive layer 14 but are instead spaced from one another some amount, either uniformly or non-uniformly. The empty portions 34 represent the area of the upper surface 22 that is exposed to the undesired objects 18 for pick-up. However, one may simply refer to the upper surface 22 without necessarily referring to the empty portions 34 and it is to be understood that these elements may be the same as described herein. The particle perimeters are designated by reference number 30 and denote the perimeter of each of the deodorizing particles 20. The particle perimeters 30 are spaced slightly from the deodorizing particles 20 for purposes of clarity in the figures. Further, the particle perimeters 30 are measured flush at the upper surface 22 so that ledges and overhangs of the deodorizing particles 20 may not be included in the measurement of the particle perimeters 30. Each one of the deodorizing particles 20 may be an individual deodorizing particle 20 or may be a series of grouped deodorizing particles 20 such that they form a generally contiguous perimeter, although it is to be understood that some amount of the upper surface 22 may be present within the particle perimeters 30 in some arrangements. The particle perimeters 30 may be the areas of the total upper surface incapable of lifting undesired objects 18.

Applicants have unexpectedly discovered that the adhesion properties of the upper surface 22 with the undesired objects 18 is improved if the deodorizing particles 20 are organized into rows 32 as opposed to random distribution across the upper surface 22. The rows 32 may be lengthwise, widthwise, diagonal, or varied in other arrangements. Further, instead of rows 32, the deodorizing particles 20 can be arranged into other shapes in other embodiments. In order to form the rows 32, a template having the desired shape can be placed over the adhesive layer 14. The deodorizing particles 20, and cyclodextrin 24 if present, can be inserted through the apertures of the template so that their desired location on the adhesive layer 14 is realized.

The total surface area of the deodorizing member 10 may be the combined amount of all of the particle perimeters 30 plus the total amount of the upper surface 22 that is not covered by the deodorizing particles 20. The total amount of the area of all of the particle perimeters 30 may be 25% of the total surface area in one embodiment. This area percentage may equate to 1.4 g/ft² of baking soda present within particle perimeters 30, or 0.24 grams of baking soda within a sheet of deodorizing member 10 that is 4″ by 6″. In other arrangements, the total amount of the area of all of the particle perimeters 30 may be 12% of the total surface area, while the area of the upper surface 22 is 88% of the total surface area. In yet other arrangements, the total amount of the combined amount of the particle perimeters 30 may be from 12%-25% of the total surface area. In yet other designs of the deodorizing member 10, other area percentages are possible. In accordance with some exemplary embodiments, the upper surface 22 has a surface area that is at least 75% of the total surface area.

When the total amount of all of the area of the particle perimeters 30 is 12% of the total surface area, the amount of baking soda deodorizing particles 20 may be 0.7 g/ft². This amount of baking soda deodorizing particles 20 may be 0.12 g for every sheet of deodorizing member 10 that is 4″ by 6″. It was found that changing the amount to 12% from 25% improved pickup of undesired objects 18 that were lint. Further, the number of particle perimeters 30 was increased to result in improved pickup of undesired objects 18 that were long pieces of hair. Although a specific distribution of the deodorizing particles 20 is disclosed, it is to be understood that the deodorizing particles 20 may be randomly distributed on the upper surface 22 so that rows 32 and empty portions 34 are not present. Although such an arrangement may reduce the pick-up capability of the adhesive layer 14, it may improve the deodorization capability of the deodorizing member 10. For embodiments where random distribution of deodorizing particles occurs, the tackiness of the PSA may be increased to provide for better lint adhesion.

The deodorizing member 10 may be arranged into a number of different tools to effect both a cleaning and a deodorizing to the item 16. With reference to FIGS. 5-7, the deodorizing member 10 may be arranged as a lint brush with which a user may run over his or her clothing to remove undesired objects 18 such as lint from the fabric of the clothing. The base sheet 12, adhesive layer 14, and deodorizing particles 20 can be arranged into a series of sections 36 that are curved and lay on one another. The sections 36 may be continuous sections that are perforated in order to be removed from one another. In other embodiments, the sections 36 are not attached and perforated with one another but are instead separate sections from one another but are still wound on one another on top of each other. A user may grasp the handle 48 to which a mounting member 46 is rotationally mounted. The sections 36 are rigidly attached to the mounting member 46 by adhesion or other means though attachment of the lower most section 36 to the mounting member 46. The user may roll the upper section 36 across the item 16 while picking up lint 18 onto the adhesive layer 14 and absorbing odors from the item 16 by way of the deodorizing particles 20. Once the upper section 38 of the sections 36 is used up, the user may tear the upper section 38 away and dispose of same and expose the next section 36 for subsequent use.

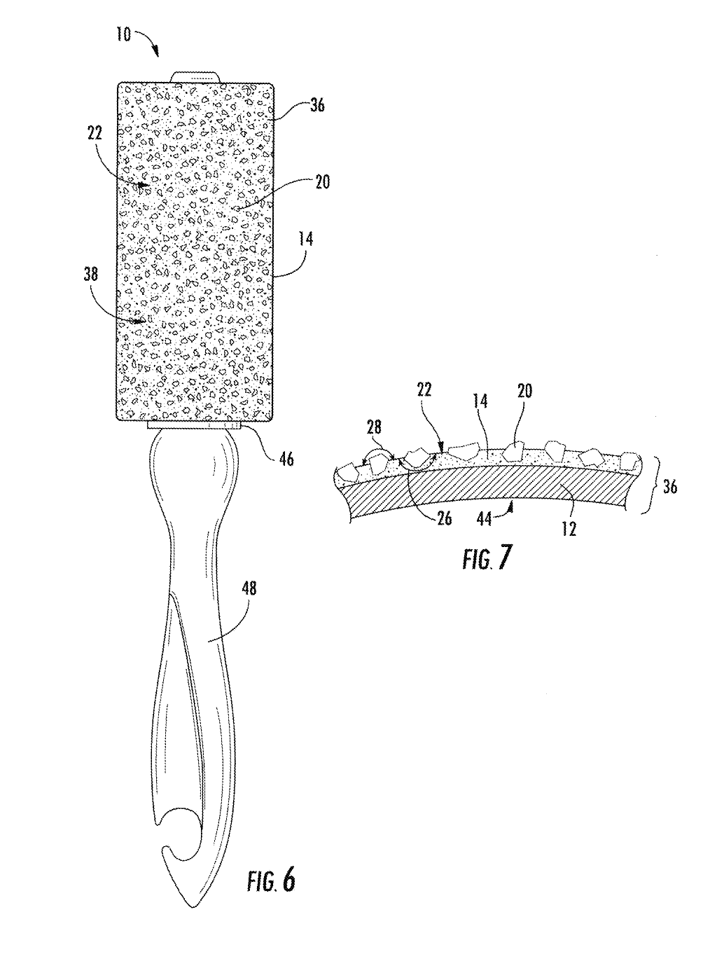

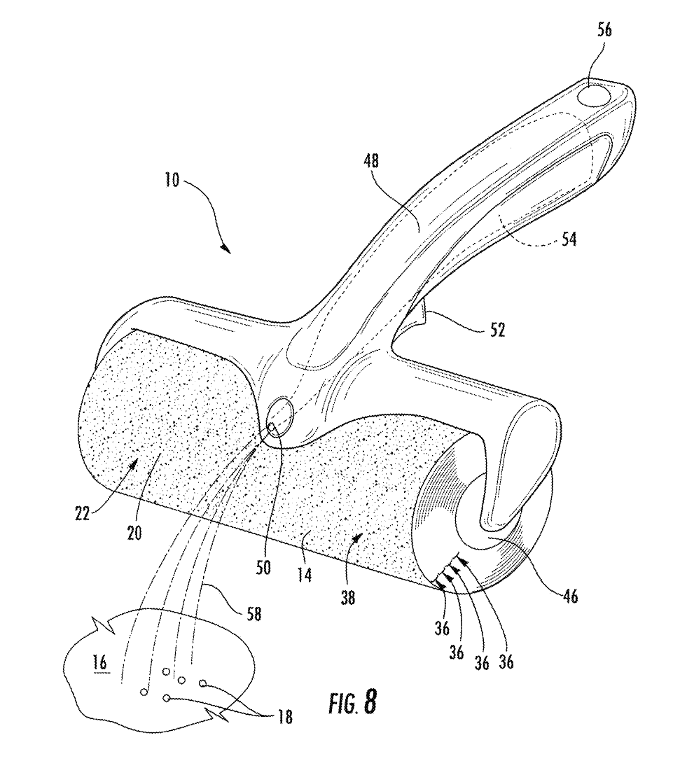

FIG. 7 illustrates a portion of the base sheet 12, adhesive layer 14, and deodorizing particles 20. As shown, these portions are curved when used as a lint brush. However, only the base sheet 12 and adhesive layer 14 may be curved in certain embodiments while the deodorizing particles 20 are less flexible objects and are not curved per se.

FIG. 8 shows another exemplary embodiment of the deodorizing member 10 as employed as a lint brush with a spray mechanism. A mounting member 46 may be rotationally mounted to a handle 48, and the sections 36 can be attached thereto in a manner similar to that previously discussed above. A spray solution 58 can be included to further deodorizing the item 16 or provide other beneficial results. The spray solution 58 can be composed in a number of different manners. It may be an aqueous solution that has 5% by weight of sodium bicarbonate. In other arrangements, the spray solution 58 may be from 1%-10% by weight of sodium bicarbonate. The spray solution 58 may include 2% by weight of potassium bicarbonate. The remaining amount of weight of the spray solution 58 may be water in some arrangements. The combination of sodium bicarbonate and potassium bicarbonate may increase shelf life and may be a more effective cleaner or deodorizer than sodium bicarbonate alone. Optionally, small amounts of a surfactant and a chelator EDTA may be included in the spray solution 58. It is to be understood that the described spray solution 58 is only exemplary and that others are possible in other arrangements. The spray solution 58 should not be antagonistic to the deodorizing process the deodorizing particles 20 and/or cyclodextrin 24 provide.

The spray solution 58 may be stored in a reservoir 54 located within the handle 48. The spray solution 58 may be added to the reservoir 54 though a filling aperture 56, or may be of a set amount and thus not refillable. The user may actuate a trigger 52 which can function to spray the spray solution 58 from a spray nozzle 50 located on an end of the handle 48. The spray solution 58 may be dispensed from the spray nozzle 50 and onto an item 16, such as fabric of a piece of clothing. The user may then push the adhesive layer 14 and deodorizing particles 20 into engagement with the item 16 to pick up lint 18 and effect deodorization of the item 16. The applied spray solution 58 may work in conjunction with the deodorizing particles 20 to increase the amount of deodorization in the instances when the deodorizing particles 20 are hydrophilic such that an increased reaction results. Further, the spray solution 58 itself may have independently beneficial properties so that it alone effects a cleaning and/or deodorization of the item 16.

The deodorizing particles 20 are shown as being randomly dispersed on the adhesive layer 14 in the roller applications of FIGS. 5-8. However, they may be arranged into rows 32 as previously discussed. The rows 32 may be arranged in a direction that is parallel to the axis of rotation of the mounting member 46, or may be arranged in a direction that extends around the circumference of the mounting member 46. Further, the rows 32 may be at an angle to the axis of revolution of the mounting member 46 or to the circumferential direction of the mounting member 46.

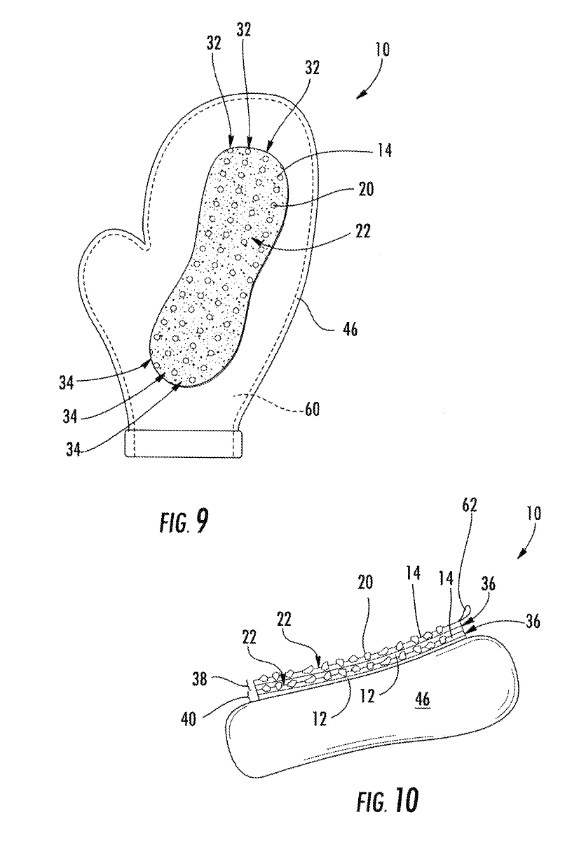

FIG. 9 shows another exemplary embodiment in which the deodorizing member 10 is configured as a hand glove. A user may slide his or her hand into the interior 60 of the glove and then brush the deodorizing particles 20 and adhesive layer 14 across an item 16 such as a piece of furniture, a counter top, an animal, or a piece of clothing. The outer perimeter of the adhesive layer 14 may be irregularly shaped due to the fact that the surface of the glove is irregularly shaped. The deodorizing particles 20 can be aligned into a series of rows 32 as previously discussed that may be curved or otherwise irregularly shaped from one end to the other. In other arrangements, the outer perimeter of the adhesive layer 14 is rectangular. A single section 36 may be employed, or the deodorizing member 10 can be arranged so that multiple sections 36 are included and are stacked onto one another for use of the upper section 38 and subsequent removal. The mounting member 46 is in effect the body of the glove making up the deodorizing member 10 into which the hand of the user is placed.

Another arrangement of the deodorizing member 10 is disclosed with reference to FIG. 10. Here, the deodorizing member 10 is made into a brush that has a mounting member 46 that is essentially a handle of the brush that can be grasped by a user and moved across an item 16 to effect cleaning and deodorizing. The brush may be a lint brush for an animal. The mounting member 46 can be made of any material such as plastic, wood, or metal. A pair of sections 36 can be employed. Here, the lower section 40 is attached and contacts the mounting member 46. Any attachment mechanism may be used to attach the lower section 40 to the mounting member 46 such as adhesive, mechanical fasteners, or a frictional engagement. Once the upper section 38 has been used, the user may grasp a removal tab 62 and tear the upper section 38 from the adhesive layer 14 of the lower section 40. The deodorizing member 10 can then be used in a similar manner with the fresh deodorizing particles 20 and adhesive layer 14 of the lower section 40. Although only a pair of sections 36 are shown, it is to be understood that any number may be used in other exemplary embodiments.

The various tool designs of the deodorizing member 10 discussed can be varied to include the different designs of constructing the deodorizing member 10 previously discussed. For example, the deodorizing particles 20 of the brush of FIG. 10 can be made so that they are formed into rows 32 that extend in any direction. In other embodiments, the deodorizing member 10 can further include a plurality of bristles such as those commonly employed in a hairbrush or animal grooming tool. The base of the bristles extends through the plurality of sheets 12 and are secured to a mounting member 46. In such an embodiment, following use, the upper most sheet 12 can be removed. During the sheet removal process, the adhesive surface of the sheet serves to remove any debris from the plurality of bristles, thereby providing a self cleaning feature for each bristle.

The various embodiments described herein can be modified to include features discussed in other embodiments or as discussed generally in other portions of the description.

With respect to an animal care product, the present invention provides a useful process of the following steps:

providing a base sheet have an adhesive layer carried on the base sheet, the base sheet further comprising a plurality of deodorizing particles carried by the adhesive layer, said base sheet further defining a plurality of apertures there-through, said apertures adapted for receiving there-through individual bristles of a brush, said base sheet further positioned at a base of the plurality of bristles;

deodorizing an article such as an animal;

removing the base sheet from the deodorizing member, said removing step providing a cleansing mechanism to each bristle as an adhesive portion of the base sheet engages the surface of each bristle as the sheet is removed, there by providing a fresh deodorizing base sheet along the base of the bristles.

### Experiments Conducted in Accordance with Various Exemplary Embodiments

Experiments were carried out in accordance with certain exemplary embodiments. Deodorizing particles 20 of sodium bicarbonate were added to an adhesive layer 14 so that 25% of the total area of the upper surface 22 and the particle perimeters 30 is of the particle perimeters 30. The deodorizing particles 20 were arranged into a series of rows 32 such as those shown with reference to FIG. 4. A 6″×6″ piece of cotton fabric was sprayed with 1% acetic acid solution (vinegar) 5 times to a total application of approximately 1.1 ml. On a scale of 1-5 with 5 being a very strong odor, 4 being a strong odor, 3 being a noticeable odor, 2 being a slight odor, and 1 being a very slight odor, at least 1 user noted the odor as being a 5. The pH level was noted as being 2-3.

The deodorizing member 10 having an adhesive layer 14 perimeter of 4″×6″ was applied to the cotton fabric for 10 seconds. Lint 18 was noted as being removed from the cotton fabric. A pH test indicated that upon removal, the pH level was noted as being 7 and thus neutralized. The subjective odor test was noted as being an odor level of 1 and thus being of very slight odor.

In an additional set of experiments, a cotton fabric was sprayed 5 times with the vinegar solution noted above and smelled to determine its original odor. A deodorizing member 10 was applied and removed once every few seconds from the cotton fabric for a total of 10 seconds. The cotton fabric was then smelled to determine if the odor was eliminated. The results are as follows:

| Sheet | Amount of Baking | Pattern of Baking | Smell level After |
|---|---|---|---|
| Number | Soda (g) | Soda | Application |
| 1 | 0.45 | Circles (25%) | 2 |
| 2 | 0.4 | Circles (25%) | 1 |
| 3 | 0.2 | Circles (25%) | 1 |
| 4 | 0.42 | Circles (25%) | 1 |
| 5 | 0.35 | Circles (25%) | 2 |
| 6 | 0.45 | Circles (25%) | 1 |
| 7 | 0.08 | Even Coat (very | 1 |
| | | light) | |
| 8 | 0 | None (control) | 4 |

The test data demonstrates the removal of items 18 and odors from the cotton fabric item 16 upon application of one or more of the disclosed deodorizing members 10.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A deodorizing member, comprising:
a base sheet;
an adhesive layer carried by the base sheet, wherein the adhesive layer has a tackiness sufficient to adhere undesired objects from an item thereon when the adhesive layer is placed into contact with the undesired objects; and
a plurality of deodorizing particles carried by the adhesive layer, wherein at least one of the deodorizing particles has a portion thereof that is not covered by an upper surface of the adhesive layer, wherein the deodorizing particles deodorize the item.

2. The deodorizing member as set forth in claim 1, wherein the deodorizing particles are sodium bicarbonate.

3. The deodorizing member as set forth in claim 1, wherein the deodorizing particles are selected from the group consisting of sodium bicarbonate, potassium bicarbonate, cyclodextrin, zeolite, and combination thereof.

4. The deodorizing member as set forth in claim 1, wherein some of the deodorizing particles are sodium bicarbonate and wherein some of the deodorizing particles are cyclodextrin.

5. The deodorizing member as set forth in claim 1, wherein the plurality of deodorizing particles have a bonded portion that is below the upper surface of the adhesive layer that functions to hold the deodorizing particles to the adhesive, and wherein the plurality of deodorizing particles have an exposed portion that is located above the upper surface of the adhesive layer.

6. The deodorizing member as set forth in claim 5, wherein the plurality of deodorizing particles define a plurality of particle perimeters at the upper surface of the adhesive layer, wherein the surface area of the upper surface of the adhesive layer is at least 75% of the total surface area of the surface area of the upper surface of the adhesive layer plus the surface area of the particle perimeters.

7. The deodorizing member as set forth in claim 1, wherein the plurality of deodorizing particles define a plurality of particle perimeters at the upper surface of the adhesive layer, wherein the plurality of particle perimeters are arranged into a plurality of rows at the upper surface of the adhesive layer such that each one of the rows has at least two of the particle perimeters therein that are separated from one another.

8. The deodorizing member as set forth in claim 1, wherein the adhesive is a pressure sensitive adhesive.

9. The deodorizing member as set forth in claim 1, wherein the base sheet, the adhesive layer, and the plurality of deodorizing particles are arranged into a plurality of sections that are stacked on top of one another and are removable from one another, wherein the adhesive layer from one of the sections engages a bottom surface of the base sheet of a subsequent section before the subsequent section is removed.

10. A deodorizing member, comprising:
a base sheet;
an adhesive layer carried by the base sheet, wherein the adhesive layer has a tackiness sufficient to adhere undesired objects from an item thereon when the adhesive layer is placed into contact with the undesired objects;
a plurality of deodorizing particles carried by the adhesive layer, wherein the deodorizing particles deodorize the item; and
a mounting member that carries the base sheet, wherein the mounting member is capable of being manipulated by a user so as to place the adhesive layer into contact with the undesired objects of the item.

11. The deodorizing member as set forth in claim 10, further comprising a handle, wherein the mounting member is rotationally mounted to the handle such that the mounting member, base sheet, adhesive layer, and plurality of deodorizing particles are capable of rotating with respect to the handle, wherein the deodorizing member is used as a lint brush.

12. The deodorizing member as set forth in claim 11, further comprising:
a spray nozzle;
a spray trigger carried by the handle; and
a reservoir into which a spray solution is located, wherein actuation of the spray nozzle causes the spray solution to be dispensed from the spray trigger.

13. The deodorizing member as set forth in claim 12, wherein the spray solution is from 1%-10% by weight of sodium bicarbonate and is 1%-10% by weight of potassium bicarbonate.

14. The deodorizing member as set forth in claim 10, wherein the mounting member is a glove into which the hand of a user can be placed, wherein the base sheet is carried by the glove so as to be located outside of the interior of the glove.

15. The deodorizing member as set forth in claim 14, wherein the mounting member further comprises a plurality of bristles extending through the base sheet on an external surface of the glove.

16. The deodorizing member as set forth in claim 11, wherein the mounting member is a handle, wherein the base sheet, the adhesive layer, and the plurality of deodorizing particles do not rotate with respect to the handle, wherein the deodorizing member is used as a lint brush for an animal.

17. The deodorizing member as set forth in claim 11, wherein the deodorizing particles are sodium bicarbonate and wherein the base sheet, the adhesive layer, and the plurality of deodorizing particles are arranged into a plurality of sections that are stacked on top of one another and are removable from one another, wherein the adhesive layer from one of the sections engages a bottom surface of the base sheet of a subsequent section before the subsequent section is removed, wherein the bottom most section engages the mounting member.

18. A method of manufacturing a deodorizing member, comprising the steps of:
providing a base sheet;
providing a plurality of deodorizing particles that are capable of deodorizing an item that is desired to be deodorized;
providing an adhesive that is capable in use of the deodorizing member of adhering to undesired objects of the item to remove the undesired objects from the item; and
applying the adhesive onto the base sheet to form a layer of the adhesive on the base sheet, wherein the deodorizing particles are carried by the adhesive.

19. The method as set forth in claim 18, further comprising the step of mixing the adhesive and the deodorizing particles together with one another before the applying step, wherein when the adhesive is applied onto the base sheet the deodorizing particles are dispersed throughout the layer of the adhesive on the base sheet such that at least some of the deodorizing particles are located between an upper surface of the adhesive and the base sheet such that no portion of the at least some of the deodorizing particles extend above the upper surface of the adhesive.

20. The method as set forth in claim 18, wherein the deodorizing particles are made of sodium bicarbonate, and further comprising the steps of:
heating the adhesive to a temperature that is not greater than 125 degrees Celsius; and
applying the deodorizing particles to the heated adhesive such that the deodorizing particles are retained by the heated adhesive and such that at least some of the deodorizing particles have a portion thereof that extend above an upper surface of the adhesive layer.
